(19) United States
(12) Patent Application Publication
(10) Pub. No.: US 2025/0209922 A1
(43) Pub. Date: Jun. 26, 2025

(54) VEHICLE

(71) Applicant: SUBARU CORPORATION, Tokyo (JP)

(72) Inventors: Takahiro YAMAMOTO, Tokyo (JP); Naonori IKEZAWA, Tokyo (JP); Takanori TATEBE, Tokyo (JP); Minoru SUYAMA, Tokyo (JP); Sho NAGAIKE, Tokyo (JP); Hideto FUKUDA, Tokyo (JP)

(73) Assignee: SUBARU CORPORATION, Tokyo (JP)

(21) Appl. No.: 18/966,746

(22) Filed: Dec. 3, 2024

(30) Foreign Application Priority Data
Dec. 20, 2023 (JP) 2023-215279

(51) Int. Cl. G08G 1/00; B60W 30/18; H04W 4/46

(52) U.S. Cl. CPC G08G 1/22; B60W 30/18154; H04W 4/46

(57) ABSTRACT

A vehicle that is a first vehicle includes a communication device configured to communicate with a second vehicle, a position acquisition device configured to acquire a position of the first vehicle, a locator device configured to determine a position of a preceding vehicle located ahead of the first vehicle in a traveling direction, and a control device including one or more processors and one or more memories coupled to the one or more processors. The one or more processors are configured to execute a process including: when an intersection is present ahead of the first vehicle in the traveling direction, determining whether the first vehicle is able to pass through the intersection based on positional information of the preceding vehicle; and, when determination is made that the first vehicle is able to pass through the intersection, transmitting positional information of the first vehicle at the intersection to the second vehicle.

### CROSS-REFERENCE TO RELATED APPLICATION

The present application claims priority from Japanese Patent Application No. 2023-215279 filed on Dec. 20, 2023, the entire contents of which are hereby incorporated by reference.

### BACKGROUND

The disclosure relates to a vehicle.

Japanese Unexamined Patent Application Publication (JP-A) No. 2005-165643 discloses that, when a vehicle enters an intersection, determination is made as to whether there is an entry space for the vehicle ahead of the intersection. In JP-A No. 2005-165643, when determination is made that there is no entry space for the vehicle ahead of the intersection, a driver who drives the vehicle is alerted and assisted in vehicle operation.

### SUMMARY

An aspect of the disclosure provides a vehicle that is a first vehicle located ahead of a second vehicle in a traveling direction and configured to travel in an array with the second vehicle. The vehicle includes a communication device, a position acquisition device, a locator device, and a control device. The communication device is configured to communicate with the second vehicle. The position acquisition device is configured to acquire a position of the first vehicle. The locator device is configured to determine a position of a preceding vehicle located ahead of the first vehicle in the traveling direction. The control device includes one or more processors and one or more memories coupled to the one or more processors. The one or more processors are configured to execute a process including: when an intersection is present ahead of the first vehicle in the traveling direction, determining whether the first vehicle is able to pass through the intersection based on positional information of the preceding vehicle; and, when the first vehicle is determined to be able to pass through the intersection, transmitting positional information of the first vehicle at the intersection to the second vehicle.

An aspect of the disclosure provides a vehicle that is a second vehicle located behind a first vehicle in a traveling direction and configured to travel in an array with the first vehicle. The vehicle includes a communication device, a position acquisition device, and a control device. The communication device is configured to communicate with the first vehicle. The position acquisition device is configured to acquire a position of the second vehicle. The control device includes one or more processors and one or more memories coupled to the one or more processors. The one or more processors are configured to execute a process including: acquiring positional information of the first vehicle when an intersection is present ahead of the second vehicle in the traveling direction; and determining whether the second vehicle is able to pass through the intersection based on the acquired positional information of the first vehicle.

An aspect of the disclosure provides a vehicle that is a first vehicle located ahead of a second vehicle in a traveling direction and configured to travel in an array with the second vehicle. The vehicle includes one or more processors and one or more memories coupled to the one or more processors. The one or more processors are configured to execute a process comprising: causing a communication device to communicate with the second vehicle; causing a position acquisition device to acquire a position of the first vehicle; causing a locator device to determine a position of a preceding vehicle located ahead of the first vehicle in the traveling direction; when an intersection is present ahead of the first vehicle in the traveling direction, determining whether the first vehicle is able to pass through the intersection based on positional information of the preceding vehicle; and when the first vehicle is determined to be able to pass through the intersection, transmitting positional information of the first vehicle at the intersection to the second vehicle. An aspect of the disclosure provides a vehicle that is a second vehicle located behind a first vehicle in a traveling direction and configured to travel in an array with the first vehicle. The vehicle includes one or more processors and one or more memories coupled to the one or more processors. The one or more processors are configured to execute a process comprising: causing a communication device to communicate with the first vehicle; causing a position acquisition device to acquire a position of the second vehicle; acquiring positional information of the first vehicle when an intersection is present ahead of the second vehicle in the traveling direction; and determining whether the second vehicle is able to pass through the intersection based on the acquired positional information of the first vehicle.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic structural diagram illustrating the structure of an arrayed vehicle system according to an embodiment;

FIG. 2 is a block diagram illustrating an example of the configuration of a first vehicle according to the embodiment;

FIG. 3 is a block diagram illustrating an example of the functional configuration of a control device according to the embodiment;

FIG. 4 is a flowchart illustrating an intersection entry control process to be executed by the control device of the first vehicle according to the embodiment;

FIG. 5 is a schematic structural diagram illustrating the arrayed vehicle system when the first vehicle has entered the intersection; and

FIG. 6 is a flowchart illustrating an intersection entry control process to be executed by the control device of a second vehicle according to the embodiment.

### DETAILED DESCRIPTION

When arrayed vehicles enter an intersection, the traffic light may change from green to yellow. Therefore, the vehicles check safety to enter the intersection. If each of the arrayed vehicles stops at a stop line behind the intersection and checks safety to enter the intersection, the arrayed vehicles may have difficulty in smoothly passing through the intersection due to a long period for the check process.

It is desirable to provide a vehicle that can smoothly pass through an intersection.

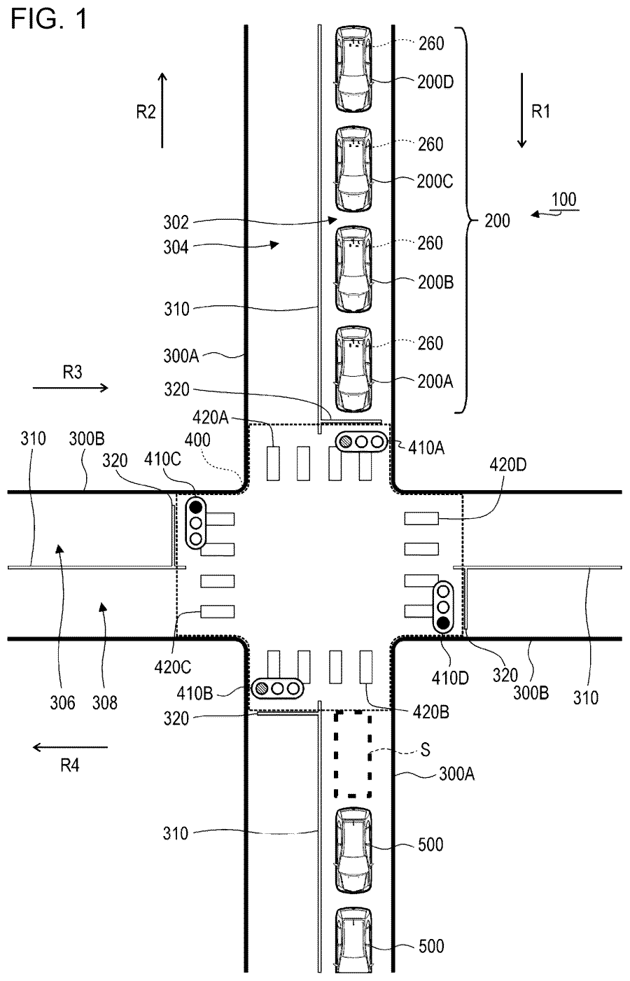

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. FIG. 1 is a schematic structural diagram illustrating the structure of an arrayed vehicle system 100 according to this embodiment. As illustrated in FIG. 1, the arrayed vehicle system 100 includes arrayed vehicles 200. The vehicles 200 are configured to communicate with each other. The vehicles 200 are configured to execute autonomous driving control. In this embodiment, the vehicles 200 are autonomously traveling in an array along a first road 300A. In the example illustrated in FIG. 1, vehicles 500 other than the arrayed vehicles 200 are also traveling along the first road 300A.

In the example illustrated in FIG. 1, the arrayed vehicles 200 include a first vehicle 200A, a second vehicle 200B, a third vehicle 200C, and a fourth vehicle 200D. The arrayed vehicles 200 may be two or more vehicles 200 that are, for example, the first vehicle 200A and the second vehicle 200B. The arrayed vehicles 200 may be five or more vehicles 200.

In the example illustrated in FIG. 1, the arrayed vehicles 200 are traveling along the first road 300A. A second road 300B other than the first road 300A intersects the first road 300A at 90°. An intersection 400 is provided at the part where the first road 300A intersects the second road 300B. In this embodiment, the first road 300A is orthogonal to the second road 300B, but the first road 300A may intersect the second road 300B at an angle larger than 0° and smaller than 90°. In the following example, the first road 300A is orthogonal to the second road 300B.

The first road 300A has a white continuous center line 310. On one side across the center line 310, the first road 300A includes a first-direction road 302 where the vehicles 200 and 500 travel in a first direction R1. On the other side across the center line 310, the first road 300A includes a second-direction road 304 where the vehicles 200 and 500 travel in a second direction R2 opposite to the first direction R1.

The second road 300B has a white continuous center line 310. On one side across the center line 310, the second road 300B includes a third-direction road 306 where the vehicles 200 and 500 travel in a third direction R3 orthogonal to the first direction R1 and the second direction R2. On the other side across the center line 310, the second road 300B includes a fourth-direction road 308 where the vehicles 200 and 500 travel in a fourth direction R4 opposite to the third direction R3.

In the example illustrated in FIG. 1, the arrayed vehicles 200 and the other vehicles 500 are traveling in the first direction R1 along the first-direction road 302 in the first road 300A.

For traffic safety in the first-direction road 302, the first-direction road 302 has a first traffic light 410A showing a go-ahead or stop signal for the vehicles 200 and 500. The first-direction road 302 has a white continuous stop line 320 behind the first traffic light 410A in the first direction R1. The stop line 320 indicates a stop position of the vehicles 200 and 500. To ensure visibility for the drivers of the vehicles 200 and 500, the first traffic light 410A is positioned higher than the heights of the vehicles 200 and 500 from the ground of the first-direction road 302. The first-direction road 302 has a first crosswalk 420A ahead of the stop line 320 in the first direction R1. The first crosswalk 420A is an area provided on the first road 300A so that pedestrians can safely cross the first road 300A.

For traffic safety in the second-direction road 304, the second-direction road 304 has a second traffic light 410B showing a go-ahead or stop signal for the vehicles 200 and 500. The second-direction road 304 has a white continuous stop line 320 behind the second traffic light 410B in the second direction R2. To ensure visibility for the drivers of the vehicles 200 and 500, the second traffic light 410B is positioned higher than the heights of the vehicles 200 and 500 from the ground of the second-direction road 304. The second-direction road 304 has a second crosswalk 420B ahead of the stop line 320 in the second direction R2. The second crosswalk 420B is an area provided on the first road 300A so that pedestrians can safely cross the first road 300A. The second crosswalk 420B is provided behind the first crosswalk 420A in the second direction R2. The second road 300B is provided between the first crosswalk 420A and the second crosswalk 420B. That is, the first crosswalk 420A is positioned ahead of the stop line 320 of the first-direction road 302 in the first direction R1 and behind the second road 300B in the first direction R1. The second crosswalk 420B is positioned ahead of the stop line 320 of the second-direction road 304 in the second direction R2 and behind the second road 300B in the second direction R2.

For traffic safety in the third-direction road 306, the third-direction road 306 has a third traffic light 410C showing a go-ahead or stop signal for the vehicles 200 and 500. The third-direction road 306 has a white continuous stop line 320 behind the third traffic light 410C in the third direction R3. The third-direction road 306 has a third crosswalk 420C ahead of the stop line 320 in the third direction R3. The third crosswalk 420C is an area provided on the second road 300B so that pedestrians can safely cross the second road 300B.

For traffic safety in the fourth-direction road 308, the fourth-direction road 308 has a fourth traffic light 410D showing a go-ahead or stop signal for the vehicles 200 and 500. The fourth-direction road 308 has a white continuous stop line 320 behind the fourth traffic light 410D in the fourth direction R4. The fourth-direction road 308 has a fourth crosswalk 420D ahead of the stop line 320 in the fourth direction R4. The fourth crosswalk 420D is an area provided on the second road 300B so that pedestrians can safely cross the second road 300B. The fourth crosswalk 420D is provided behind the third crosswalk 420C in the fourth direction R4. The first road 300A is provided between the third crosswalk 420C and the fourth crosswalk 420D. That is, the third crosswalk 420C is positioned ahead of the stop line 320 of the third-direction road 306 in the third direction R3 and behind the first road 300A in the third direction R3. The fourth crosswalk 420D is positioned ahead of the stop line 320 of the fourth-direction road 308 in the fourth direction R4 and behind the first road 300A in the fourth direction R4.

The intersection 400 includes a part where the first road 300A intersects the second road 300B and, in this embodiment, is an area surrounded by the four stop lines 320 of the first road 300A and the second road 300B, that is, surrounded by a dashed line in FIG. 1. In other words, the first road 300A and the second road 300B have the stop lines 320 immediately behind the entrances of the intersection 400. The intersection 400 may be an area surrounded by the first crosswalk 420A, the second crosswalk 420B, the third crosswalk 420C, and the fourth crosswalk 420D. For example, the intersection 400 may be an area surrounded by the sides of the first crosswalk 420A and the second crosswalk 420B near the second road 300B and the sides of the third crosswalk 420C and the fourth crosswalk 420D near the first road 300A.

In the example illustrated in FIG. 1, the area of the intersection 400 includes the first traffic light 410A, the second traffic light 410B, the third traffic light 410C, and the fourth traffic light 410D, the first crosswalk 420A, the second crosswalk 420B, the third crosswalk 420C, and the fourth crosswalk 420D. In this embodiment, the intersection 400 is an area located ahead of the stop line 320 of the first-direction road 302 in the first direction R1 and ahead of the stop line 320 of the second-direction road 304 in the second direction R2. The intersection 400 is an area located ahead of the stop line 320 of the third-direction road 306 in the third direction R3 and ahead of the stop line 320 of the fourth-direction road 308 in the fourth direction R4.

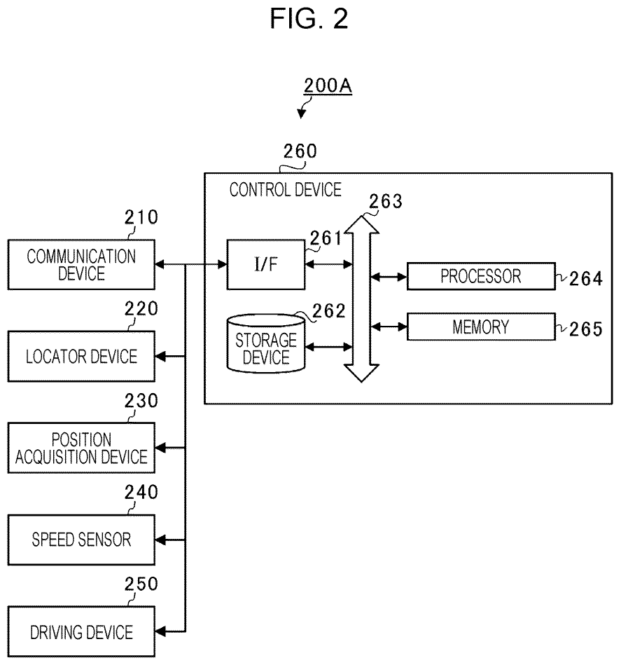

FIG. 2 is a block diagram illustrating an example of the configuration of the first vehicle 200A according to this embodiment. The configurations of the second vehicle 200B, the third vehicle 200C, and the fourth vehicle 200D are the same as that of the first vehicle 200A. The configuration of the first vehicle 200A is described in detail, and detailed description is omitted for the configurations of the second vehicle 200B, the third vehicle 200C, and the fourth vehicle 200D.

As illustrated in FIG. 2, the first vehicle 200A includes a communication device 210, a locator device 220, a position acquisition device 230, a speed sensor 240, a driving device 250, and a control device 260.

The communication device 210 transmits and receives data by establishing communication with the communication devices 210 of the second vehicle 200B, the third vehicle 200C, and the fourth vehicle 200D based on a control command from the control device 260. For example, the communication device 210 wirelessly transmits data from the control device 260 to the communication devices 210 of the second vehicle 200B, the third vehicle 200C, and the fourth vehicle 200D. The communication device 210 receives data wirelessly transmitted from the communication devices 210 of the second vehicle 200B, the third vehicle 200C, and the fourth vehicle 200D, and transmits the received data to the control device 260.

The locator device 220 identifies objects in the surrounding environment of the first vehicle 200A. The locator device 220 identifies objects around the first vehicle 200A by, for example, processing images captured by imaging devices. The objects around the first vehicle 200A include the other vehicles 500 located ahead of the first vehicle 200A in the traveling direction, and the four stop lines 320 of the first road 300A and the second road 300B. The locator device 220 identifies the intersection 400 based on the four stop lines 320 of the first road 300A and the second road 300B. The objects around the first vehicle 200A also include the first crosswalk 420A, the second crosswalk 420B, the third crosswalk 420C, and the fourth crosswalk 420D. For example, the locator device 220 may identify the other vehicles 500 located ahead of the first vehicle 200A in the traveling direction using a laser. The locator device 220 may identify the stop lines 320, the intersection 400, the first crosswalk 420A, the second crosswalk 420B, the third crosswalk 420C, and the fourth crosswalk 420D based on current positional information of the first vehicle 200A and map information.

The position acquisition device 230 acquires positional information on the position of the first vehicle 200A. Examples of the position acquisition device 230 include a global positioning system (GPS) receiver. For example, the position acquisition device 230 acquires positional information on latitude and longitude indicating the current position of the first vehicle 200A.

The speed sensor 240 measures a vehicle speed and an acceleration of the first vehicle 200A, and transmits information indicating the measured vehicle speed and the measured acceleration to the control device 260.

The driving device 250 executes accelerator, brake, and steering operations for the first vehicle 200A. During the autonomous driving control for autonomously driving the first vehicle 200A without driver's operations, the driving device 250 automatically executes the accelerator, brake, and steering operations based on a control command transmitted from the control device 260. Through the automatic control of the driving device 250, the first vehicle 200A travels autonomously.

The control device 260 controls the overall first vehicle 200A. The control device 260 includes an I/F 261, a storage device 262, a system bus 263, one or more processors 264, and one or more memories 265. The I/F 261 is an interface for communicating with the communication device 210, the locator device 220, the position acquisition device 230, the speed sensor 240, and the driving device 250.

The storage device 262 includes a RAM, a flash memory, an HDD, etc., and holds various types of information for processes to be executed by the processor 264. The system bus 263 is a transmission path that electrically couples the I/F 261, the storage device 262, the processor 264, and the memory 265 and transmits data among them.

The processor 264 includes, for example, a central processing unit (CPU). The memory 265 includes, for example, a read only memory (ROM) and a random access memory (RAM). The ROM is a storage element that stores programs and arithmetic parameters to be used by the CPU. The RAM is a storage element that temporarily stores data such as variables and parameters to be used for processes executed by the CPU.

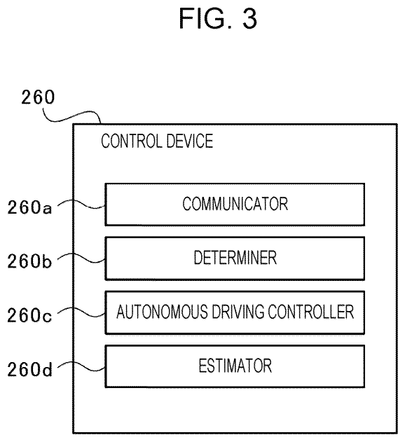

FIG. 3 is a block diagram illustrating an example of the functional configuration of the control device 260 according to this embodiment. For example, as illustrated in FIG. 3, the control device 260 includes a communicator 260a, a determiner 260b, an autonomous driving controller 260c, and an estimator 260d.

The processor 264 illustrated in FIG. 2 cooperates with and executes a program in the memory 265 to implement various processes including the processes to be executed by the communicator 260a, the determiner 260b, the autonomous driving controller 260c, and the estimator 260d as described below.

The communicator 260a exchanges data with the vehicles 200 traveling in an array via the communication device 210. The communicator 260a acquires vehicle information from the vehicles 200 traveling in the array. The vehicle information includes, for example, identification information for identifying the vehicle 200, and positional information. Examples of the identification information include vehicle identification number (VIN) information. The VIN information includes a serial number to be used for identifying each vehicle 200. Examples of the positional information include information indicating latitude and longitude of the vehicle 200 detected by the position acquisition device 230 mounted on the vehicle 200. The communicator 260a communicates with the communication device 210, the locator device 220, the position acquisition device 230, the speed sensor 240, and the driving device 250.

The determiner 260b determines whether the vehicle 200 is able to pass through the intersection 400 safely. The autonomous driving controller 260c controls the driving device 250 to execute the autonomous driving control for autonomously driving the vehicle 200 without driver's operations. The estimator 260d estimates the rear end position of the vehicle 200 at the time of stop based on a braking distance during braking of the vehicle 200 through the brake operation. The processes to be executed by the communicator 260a, the determiner 260b, the autonomous driving controller 260c, and the estimator 260d are described later in detail.

When the arrayed vehicles 200 enter the intersection 400 as illustrated in FIG. 1, the first traffic light 410A may change from green to yellow. Therefore, the arrayed vehicles 200 check safety to enter the intersection 400. If each of the arrayed vehicles 200 stops at the stop line 320 behind the intersection 400 and checks safety to enter the intersection 400, the arrayed vehicles 200 may have difficulty in smoothly passing through the intersection 400 due to a long period for the check process.

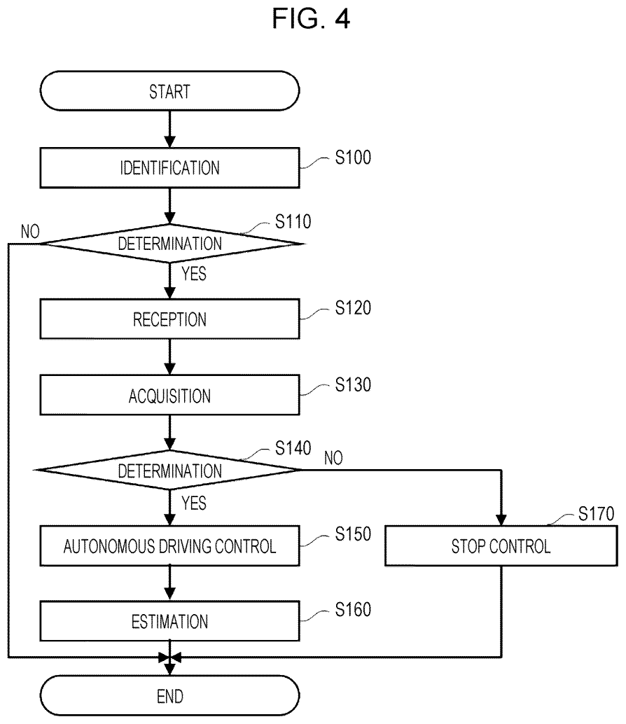

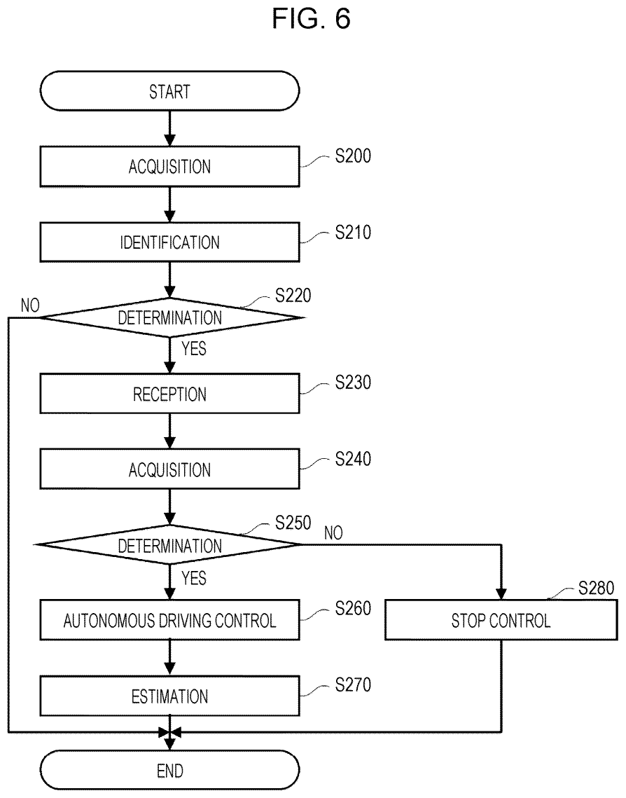

In this embodiment, the period for the safety check process is reduced in such a manner that, when determination is made that a preceding vehicle is able to pass through an intersection, information on an estimated rear end position of the preceding vehicle at the time of stop is transmitted to a succeeding vehicle, and determination is made, based on the information, as to whether the succeeding vehicle is able to pass through the intersection. For example, when the preceding first vehicle 200A out of the arrayed vehicles 200 determines that the first vehicle 200A is able to pass through the intersection 400 safely, the first vehicle 200A transmits positional information of the first vehicle 200A at the intersection 400 to the succeeding second vehicle 200B. The second vehicle 200B determines, based on the positional information of the first vehicle 200A transmitted from the first vehicle 200A, whether the second vehicle 200B is able to pass through the intersection 400 safely. Processes to be executed by the first vehicle 200A and the second vehicle 200B according to this embodiment are described in detail. Processes to be executed by the third vehicle 200C and the fourth vehicle 200D are the same as that of the second vehicle 200B, and detailed description is omitted. The process to be executed by the first vehicle 200A is first described in detail with reference to FIG. 4, and then the process to be executed by the second vehicle 200B is described in detail with reference to FIG. 6.

FIG. 4 is a flowchart illustrating an intersection entry control process to be executed by the control device 260 of the first vehicle 200A according to this embodiment. The locator device 220 of the first vehicle 200A identifies objects in the surrounding environment of the first vehicle 200A (S100). The locator device 220 identifies the other vehicles 500, the stop lines 320, the first crosswalk 420A, the second crosswalk 420B, the third crosswalk 420C, and the fourth crosswalk 420D located ahead of the first vehicle 200A in the traveling direction. The locator device 220 identifies the intersection 400 based on the four stop lines 320 of the first road 300A and the second road 300B.

Information on the objects identified by the locator device 220 is transmitted to the control device 260. The communicator 260a of the control device 260 acquires the information on the objects from the locator device 220. Based on the information on the objects, the determiner 260b calculates the rear end position of the other vehicle 500 preceding the first vehicle 200A and the positions of the stop lines 320, the intersection 400, the first crosswalk 420A, the second crosswalk 420B, the third crosswalk 420C, and the fourth crosswalk 420D.

At this time, the determiner 260b may acquire positional information on latitude and longitude indicating the current position of the first vehicle 200A from the position acquisition device 230. The determiner 260b may acquire positional information on latitude and longitude indicating the current position of the preceding other vehicle 500 by executing vehicle-to-vehicle communication with the other vehicle 500 via the communication device 210. The determiner 260b may calculate the rear end position of the other vehicle 500 based on the pieces of positional information acquired from the position acquisition device 230 and the other vehicle 500.

Based on the information on the objects acquired from the locator device 220, the determiner 260b determines whether the intersection 400 is present within a range of a predetermined distance ahead of the first vehicle 200A in the traveling direction (S110). When determination is made that the intersection 400 is not present within the range of the predetermined distance ahead of the first vehicle 200A in the traveling direction (NO in S110), the intersection entry control process is terminated. When determination is made that the intersection 400 is present within the range of the predetermined distance ahead of the first vehicle 200A in the traveling direction (YES in S110), the process proceeds to S120 onwards.

The communicator 260a receives, from a server (not illustrated), time information indicating times of color changes of the first traffic light 410A, the second traffic light 410B, the third traffic light 410C, and the fourth traffic light 410D at the intersection 400 (S120). The server (not illustrated) holds the time information indicating the times of color changes of the first traffic light 410A, the second traffic light 410B, the third traffic light 410C, and the fourth traffic light 410D at the intersection 400. The time information includes, for example, information indicating the times at which the first traffic light 410A changes from green to yellow, from yellow to red, and from red to green. At this time, the communicator 260a identifies the first traffic light 410A associated with the first-direction road 302 where the first vehicle 200A is traveling based on the current positional information of the first vehicle 200A and the map information. The communicator 260a acquires the time information indicating the times of color changes of the identified first traffic light 410A from the server (not illustrated).

The communicator 260a acquires speed information on the vehicle speed and the acceleration of the first vehicle 200A from the speed sensor 240 (S130).

Based on the stop line 320 identified in S100, the time information received in S120 and indicating the times of color changes of the first traffic light 410A, and the speed information acquired in S130, the determiner 260b determines whether the first vehicle 200A is able to pass through the intersection 400 safely (S140). For example, the determiner 260b determines whether the color of the first traffic light 410A is expected to change to a color for restriction of movement of the vehicles 200 before the first vehicle 200A reaches the stop line 320 on the first-direction road 302. The change to the color for restriction of movement of the vehicles 200 is, for example, the change in the color of the first traffic light 410A from green to yellow or from yellow to red. In the following example, the determiner 260b determines whether the first traffic light 410A is expected to change from green to yellow before the first vehicle 200A reaches the stop line 320 on the first-direction road 302.

The determiner 260b determines whether a stop space S for the first vehicle 200A is present ahead of the intersection 400 through which the first vehicle 200A is expected to pass. For example, as illustrated in FIG. 1, determination is made as to whether the length between the intersection 400 and the rear end position of the other vehicle 500 preceding the first vehicle 200A is equal to or larger than a length corresponding to the overall length of the first vehicle 200A. When the length between the intersection 400 and the rear end position of the other vehicle 500 is equal to or larger than the length corresponding to the overall length of the first vehicle 200A, determination is made that the stop space S for the first vehicle 200A is present. When the length between the intersection 400 and the rear end position of the other vehicle 500 is smaller than the length corresponding to the overall length of the first vehicle 200A, determination is made that the stop space S for the first vehicle 200A is not present.

When the first traffic light 410A is expected to change from green to yellow before the first vehicle 200A reaches the stop line 320, the determiner 260b determines that the first vehicle 200A is not able to pass through the intersection 400 safely. When the stop space S for the first vehicle 200A is not present ahead of the intersection 400 through which the first vehicle 200A is expected to pass, the determiner 260b determines that the first vehicle 200A is not able to pass through the intersection 400 safely.

When the first traffic light 410A is expected to change from green to yellow after the first vehicle 200A passes through the stop line 320 and the stop space S for the first vehicle 200A is present, the determiner 260b determines that the first vehicle 200A is able to pass through the intersection 400 safely.

When determination is made that the first vehicle 200A is able to pass through the intersection 400 safely (YES in S140), the autonomous driving controller 260c executes the autonomous driving control so that the first vehicle 200A can enter the intersection 400 across the stop line 320 (S150).

When determination is made that the first vehicle 200A is able to pass through the intersection 400 safely, the estimator 260d calculates a braking distance during braking of the first vehicle 200A. Based on the braking distance, the vehicle speed, and the acceleration, the estimator 260d estimates the rear end position of the first vehicle 200A when the first vehicle 200A stops at a predetermined distance from the rear end position of the preceding other vehicle 500 or stops in the stop space S (S160). The communicator 260a transmits information on the estimated rear end position of the first vehicle 200A to the communication device 210 of the succeeding second vehicle 200B.

When determination is made that the first vehicle 200A is not able to pass through the intersection 400 safely (NO in S140), the autonomous driving controller 260c executes stop control so that the first vehicle 200A can automatically stop behind the stop line 320 (S170).

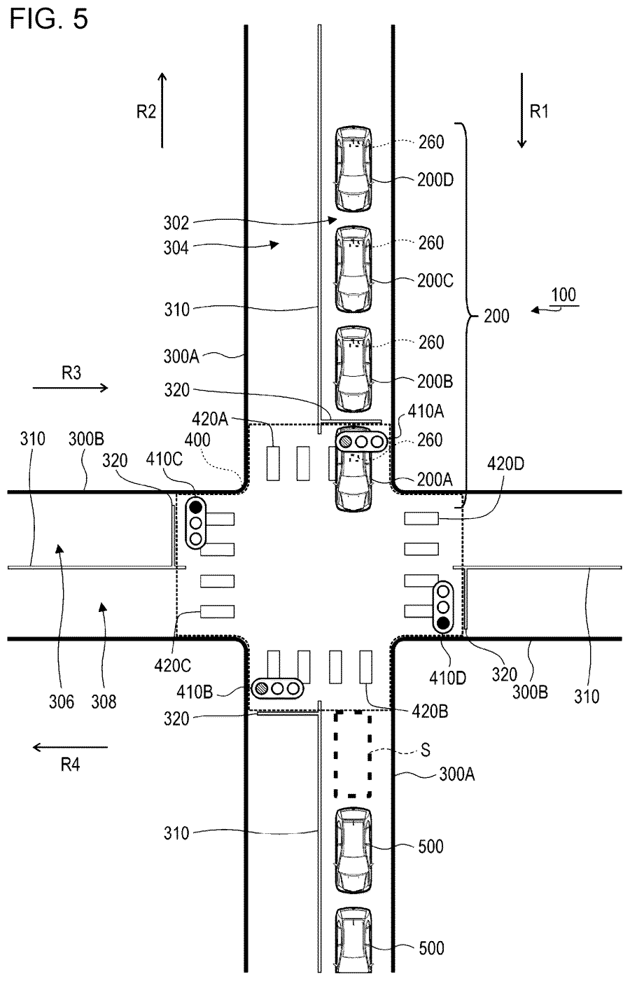

FIG. 5 is a schematic structural diagram illustrating the arrayed vehicle system 100 when the first vehicle 200A has entered the intersection 400. As illustrated in FIG. 5, the first vehicle 200A enters the intersection 400 when determination is made that the first vehicle 200A is able to pass through the intersection 400 safely. The information on the rear end position of the first vehicle 200A estimated by the estimator 260d is transmitted to the communication device 210 of the succeeding second vehicle 200B, and determination is made as to whether the second vehicle 200B is able to pass through the intersection 400 safely.

FIG. 6 is a flowchart illustrating an intersection entry control process to be executed by the control device 260 of the second vehicle 200B according to this embodiment. The communicator 260a acquires information on the rear end position of the first vehicle 200A from the communication device 210 of the first vehicle 200A (S200).

The locator device 220 of the second vehicle 200B identifies objects in the surrounding environment of the second vehicle 200B (S210). The locator device 220 identifies the stop lines 320, the first crosswalk 420A, the second crosswalk 420B, the third crosswalk 420C, and the fourth crosswalk 420D located ahead of the second vehicle 200B in the traveling direction. The locator device 220 identifies the intersection 400 based on the four stop lines 320 of the first road 300A and the second road 300B.

Information on the objects identified by the locator device 220 is transmitted to the control device 260. The communicator 260a of the control device 260 acquires the information on the objects from the locator device 220. Based on the information on the objects, the determiner 260b calculates the positions of the stop lines 320, the intersection 400, the first crosswalk 420A, the second crosswalk 420B, the third crosswalk 420C, and the fourth crosswalk 420D located ahead of the second vehicle 200B in the traveling direction.

Based on the information on the objects acquired from the locator device 220, the determiner 260b determines whether the intersection 400 is present within a range of a predetermined distance ahead of the second vehicle 200B in the traveling direction (S220). When determination is made that the intersection 400 is not present within the range of the predetermined distance ahead of the second vehicle 200B in the traveling direction (NO in S220), the intersection entry control process is terminated. When determination is made that the intersection 400 is present within the range of the predetermined distance ahead of the second vehicle 200B in the traveling direction (YES in S220), the process proceeds to S230 onwards.

The communicator 260a communicates with the server (not illustrated) to receive, from the server, time information indicating times of color changes of the first traffic light 410A, the second traffic light 410B, the third traffic light 410C, and the fourth traffic light 410D at the intersection 400 (S230). The communicator 260a identifies the first traffic light 410A associated with the first-direction road 302 where the second vehicle 200B is traveling based on the current positional information of the second vehicle 200B and the map information. The communicator 260a acquires the time information indicating the times of color changes of the identified first traffic light 410A from the server (not illustrated).

The communicator 260a acquires speed information on the vehicle speed and the acceleration of the second vehicle 200B from the speed sensor 240 (S240).

Based on the stop line 320 identified in S210, the time information received in S230 and indicating the times of color changes of the first traffic light 410A, and the speed information acquired in S240, the determiner 260b determines whether the second vehicle 200B is able to pass through the intersection 400 safely (S250). For example, the determiner 260b determines whether the first traffic light 410A is expected to change from green to yellow before the second vehicle 200B reaches the stop line 320 on the first-direction road 302.

Based on the information on the rear end position of the first vehicle 200A received in S200, the determiner 260b determines whether a stop space S for the second vehicle 200B is present ahead of the intersection 400 through which the second vehicle 200B is expected to pass. For example, determination is made as to whether the length between the intersection 400 and the estimated rear end position of the first vehicle 200A at the time of stop is equal to or larger than a length corresponding to the overall length of the second vehicle 200B. When the length between the intersection 400 and the estimated rear end position of the first vehicle 200A at the time of stop is equal to or larger than the length corresponding to the overall length of the second vehicle 200B, determination is made that the stop space S for the second vehicle 200B is present. When the length between the intersection 400 and the estimated rear end position of the first vehicle 200A at the time of stop is smaller than the length corresponding to the overall length of the second vehicle 200B, determination is made that the stop space S for the second vehicle 200B is not present.

When the first traffic light 410A is expected to change from green to yellow before the second vehicle 200B reaches the stop line 320, the determiner 260b determines that the second vehicle 200B is not able to pass through the intersection 400 safely. When the stop space S for the second vehicle 200B is not present ahead of the intersection 400 through which the second vehicle 200B is expected to pass, the determiner 260b determines that the second vehicle 200B is not able to pass through the intersection 400 safely.

When the first traffic light 410A is expected to change from green to yellow after the second vehicle 200B passes through the stop line 320 and the stop space S for the second vehicle 200B is present, the determiner 260b determines that the second vehicle 200B is able to pass through the intersection 400 safely.

When determination is made that the second vehicle 200B is able to pass through the intersection 400 safely (YES in S250), the autonomous driving controller 260c executes the autonomous driving control so that the second vehicle 200B can enter the intersection 400 across the stop line 320 (S260).

When determination is made that the second vehicle 200B is able to pass through the intersection 400 safely, the estimator 260d calculates a braking distance during braking of the second vehicle 200B. Based on the braking distance, the vehicle speed, and the acceleration, the estimator 260d estimates the rear end position of the second vehicle 200B when the second vehicle 200B stops at a predetermined distance from the rear end position of the preceding first vehicle 200A or stops in the stop space S (S270). The communicator 260a transmits information on the estimated rear end position of the second vehicle 200B to the communication device 210 of the succeeding third vehicle 200C. The third vehicle 200C and the fourth vehicle 200D execute processes similar to that of the second vehicle 200B.

When determination is made that the second vehicle 200B is not able to pass through the intersection 400 safely (NO in S250), the autonomous driving controller 260c executes stop control so that the second vehicle 200B can automatically stop behind the stop line 320 (S280).

As described above, the arrayed vehicle system 100 of this embodiment includes the first vehicle 200A that is located ahead of the second vehicle 200B in the traveling direction and travels in an array with the second vehicle 200B. The determiner 260b of the first vehicle 200A executes the process of, when the intersection 400 is present ahead of the first vehicle 200A in the traveling direction, determining whether the first vehicle 200A is able to pass through the intersection 400 based on the positional information of the preceding other vehicle 500. The communicator 260a of the first vehicle 200A executes the process of, when determination is made that the first vehicle 200A is able to pass through the intersection 400, transmitting the positional information of the first vehicle 200A at the intersection 400 to the second vehicle 200B. Thus, the second vehicle 200B can determine, before the first vehicle 200A stops in the stop space S, whether the second vehicle 200B is able to pass through the intersection 400 safely based on the positional information of the first vehicle 200A that has entered the intersection 400. Therefore, the safety check period for the entry to the intersection 400 can be reduced and the vehicle can smoothly pass through the intersection 400.

In this embodiment, the communicator 260a acquires the time information on the times of the color changes of the first traffic light 410A on the first-direction road 302.

The communicator 260a acquires the speed information on the vehicle speed and the acceleration of the first vehicle 200A from the speed sensor 240. Based on the time information and the speed information, the determiner 260b determines whether the first vehicle 200A is able to enter to the intersection 400 before the first traffic light 410A changes from green to yellow. Based on the positional information of the preceding other vehicle 500, the determiner 260b determines whether the stop space S for the first vehicle 200A is present ahead of the intersection 400 through which the first vehicle 200A is expected to pass. When the first vehicle 200A is able to enter to the intersection 400 before the color of the first traffic light 410A changes and the stop space S is present, the determiner 260b determines that the first vehicle 200A is able to pass through the intersection 400, and causes the first vehicle 200A to enter the intersection 400. Therefore, it is possible to reduce the occurrence of a case where the first vehicle 200A is located in the intersection 400 when the first traffic light 410A changes to red, and therefore reduce the risk of vehicle collision in the intersection 400.

In this embodiment, the estimator 260d estimates the rear end position of the first vehicle 200A based on the braking distance during braking of the first vehicle 200A. The communicator 260a transmits the positional information of the estimated rear end position of the first vehicle 200A to the second vehicle 200B. Therefore, the second vehicle 200B can acquire, before the first vehicle 200A stops in the stop space S, the positional information of the estimated rear end position when the first vehicle 200A stops in the stop space S.

The arrayed vehicle system 100 of this embodiment includes the second vehicle 200B that is located behind the first vehicle 200A in the traveling direction and travels in an array with the first vehicle 200A. The communicator 260a of the second vehicle 200B executes the process of acquiring the positional information of the first vehicle 200A when the intersection 400 is present ahead of the second vehicle 200B in the traveling direction. The determiner 260b executes the process of determining whether the second vehicle 200B is able to pass through the intersection 400 based on the acquired positional information of the first vehicle 200A. Thus, the second vehicle 200B can determine, before the first vehicle 200A stops in the stop space S, whether the second vehicle 200B is able to pass through the intersection 400 safely based on the positional information of the first vehicle 200A that has entered the intersection 400. Therefore, the safety check period for the entry to the intersection 400 can be reduced and the vehicle can smoothly pass through the intersection 400.

In this embodiment, the communicator 260a of the second vehicle 200B acquires the time information on the times of the color changes of the first traffic light 410A at the intersection 400. The communicator 260a acquires the speed information on the vehicle speed and the acceleration of the second vehicle 200B. Based on the time information and the speed information, the determiner 260b determines whether the second vehicle 200B is able to enter to the intersection 400 before the first traffic light 410A changes from green to yellow. Based on the positional information of the first vehicle 200A, the determiner 260b determines whether the stop space S for the second vehicle 200B is present ahead of the intersection 400 through which the second vehicle 200B is expected to pass. When the second vehicle 200B is able to enter to the intersection 400 before the color of the first traffic light 410A changes and the stop space S is present, the determiner 260b determines that the second vehicle 200B is able to pass through the intersection 400, and causes the second vehicle 200B to enter the intersection 400. Therefore, it is possible to reduce the occurrence of a case where the second vehicle 200B is located in the intersection 400 when the first traffic light 410A changes to red, and therefore reduce the risk of vehicle collision in the intersection 400.

Although the exemplary embodiment of the disclosure is described above with reference to the accompanying drawings, the embodiment of the disclosure is not limited to this embodiment. It is understood that various modifications and revisions are conceivable by persons having ordinary skill in the art within the scope of claims and are included in the technical scope disclosed herein.

The series of processes to be executed by the control device 260 of this embodiment may be implemented using software, hardware, or a combination of software and hardware. Programs serving as software are prestored in, for example, non-transitory media provided inside or outside each device. For example, the programs are read from the non-transitory medium (e.g., a ROM), loaded in a transitory medium (e.g., a RAM), and executed by a processor such as a CPU.

The programs for implementing the functions of each device can be created and installed in a computer of each device. A processor executes the programs stored in a memory to execute the processes of the functions. At this time, the programs may be executed by multiple processors in cooperation, or may be executed by a single processor. The functions of each device may be implemented by cloud computing using multiple computers coupled to each other via a communication network. The programs may be installed by being provided to the computer of each device through distribution from an external device via a communication network.

The control device 260 illustrated in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 260 including the communicator 260a, the determiner 260b, the autonomous driving controller 260c, and the estimator 260d. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 3.

1. A vehicle that is a first vehicle located ahead of a second vehicle in a traveling direction and configured to travel in an array with the second vehicle, the vehicle comprising:
a communication device configured to communicate with the second vehicle;
a position acquisition device configured to acquire a position of the first vehicle;
a locator device configured to determine a position of a preceding vehicle located ahead of the first vehicle in the traveling direction; and
a control device comprising one or more processors and one or more memories coupled to the one or more processors,
wherein the one or more processors are configured to execute a process comprising:
when an intersection is present ahead of the first vehicle in the traveling direction, determining whether the first vehicle is able to pass through the intersection based on positional information of the preceding vehicle; and
when the first vehicle is determined to be able to pass through the intersection, transmitting positional information of the first vehicle at the intersection to the second vehicle.

2. The vehicle according to claim 1, wherein the one or more processors are configured to execute a process comprising:
acquiring time information on a time of change in a color of a traffic light at the intersection;
acquiring speed information on a vehicle speed and an acceleration of the first vehicle;
determining, based on the time information and the speed information, whether the first vehicle is able to enter to the intersection before the color of the traffic light changes to a color for restriction of movement of the vehicle;
determining, based on the positional information of the preceding vehicle, whether a stop space for the first vehicle is present ahead of the intersection through which the first vehicle is expected to pass; and
when the first vehicle is able to enter to the intersection before the color of the traffic light changes to the color for restriction of movement of the vehicle and the stop space is present, determining that the first vehicle is able to pass through the intersection, and causing the first vehicle to enter the intersection.

3. The vehicle according to claim 1, wherein the one or more processors are configured to execute a process comprising:
estimating a rear end position of the first vehicle based on a braking distance during braking of the first vehicle; and
transmitting positional information of the estimated rear end position of the first vehicle to the second vehicle.

4. The vehicle according to claim 2, wherein the one or more processors are configured to execute a process comprising:
estimating a rear end position of the first vehicle based on a braking distance during braking of the first vehicle; and
transmitting positional information of the estimated rear end position of the first vehicle to the second vehicle.

5. A vehicle that is a second vehicle located behind a first vehicle in a traveling direction and configured to travel in an array with the first vehicle, the vehicle comprising:
a communication device configured to communicate with the first vehicle;
a position acquisition device configured to acquire a position of the second vehicle; and
a control device comprising one or more processors and one or more memories coupled to the one or more processors,
wherein the one or more processors are configured to execute a process comprising:
acquiring positional information of the first vehicle when an intersection is present ahead of the second vehicle in the traveling direction; and
determining whether the second vehicle is able to pass through the intersection based on the acquired positional information of the first vehicle.

6. The vehicle according to claim 5, wherein the one or more processors are configured to execute a process comprising:
acquiring time information on a time of change in a color of a traffic light at the intersection;
acquiring speed information on a vehicle speed and an acceleration of the second vehicle;
determining, based on the time information and the speed information, whether the second vehicle is able to enter to the intersection before the color of the traffic light changes to a color for restriction of movement of the vehicle;
determining, based on the positional information of the first vehicle, whether a stop space for the second vehicle is present ahead of the intersection through which the second vehicle is expected to pass; and
when the second vehicle is able to enter to the intersection before the color of the traffic light changes to the color for restriction of movement of the vehicle and the stop space is present, determining that the second vehicle is able to pass through the intersection, and causing the second vehicle to enter the intersection.

7. A vehicle that is a first vehicle located ahead of a second vehicle in a traveling direction and configured to travel in an array with the second vehicle, the first and second vehicles comprising one or more processors and one or more memories coupled to the one or more processors, wherein
the one or more processors of the first vehicle are configured to execute a process comprising:
causing a communication device to communicate with the second vehicle;
causing a position acquisition device to acquire a position of the first vehicle;
causing a locator device to determine a position of a preceding vehicle located ahead of the first vehicle in the traveling direction;
when an intersection is present ahead of the first vehicle in the traveling direction, determining whether the first vehicle is able to pass through the intersection based on positional information of the preceding vehicle; and
when the first vehicle is determined to be able to pass through the intersection, transmitting positional information of the first vehicle at the intersection to the second vehicle.

8. The vehicle according to claim 7, wherein the one or more processors of the second vehicle are configured to execute a process comprising:
causing a communication device to communicate with the first vehicle;
causing a position acquisition device to acquire a position of the second vehicle;
acquiring positional information of the first vehicle when an intersection is present ahead of the second vehicle in the traveling direction; and
determining whether the second vehicle is able to pass through the intersection based on the acquired positional information of the first vehicle.
